(19) United States
(12) Patent Application Publication
(10) Pub. No.: US 2015/0063469 A1
(43) Pub. Date: Mar. 5, 2015

(54) MULTIPASS ENCODER WITH HETEROGENEOUS CODECS

(71) Applicant: ARRIS Enterprises, Inc., Suwanee, GA (US)

(72) Inventors: Pierre Seigneurbieux, Mountain View, CA (US); Shivkumar Jayaraman, Cupertino, CA (US); Venkatram Vajjhula, Fremont, CA (US)

(21) Appl. No.: 14/474,509

(22) Filed: Sep. 2, 2014

Related U.S. Application Data
(60) Provisional application No. 61/871,958, filed on Aug. 30, 2013.

(51) Int. Cl. H04N 19/90

(52) U.S. Cl. CPC H04N 19/00945
USPC 375/240.26

(57) ABSTRACT

A multipass encoder is provided with heterogeneous codecs. In one example the system includes a MPEG-4 encoder to perform a less complex first pass encoding followed by a second pass more complex HEVC encoder. The system allows for a faster development cycle of a multipass encoder for a newly introduced codec by reusing the infrastructure and multipass design of an established video encoder already dealing with older technology. This multipass system allows bringing existing technology to a new codec with the constraints of the pre-existing codec limitations, particularly in terms of CPU cycles, to make use of the new codec more economically practical.

### CLAIM FOR PRIORITY

This Application claims priority under 35 U.S.C. §119(e) from earlier filed U.S. Provisional Application Ser. No. 61/871,958 filed on Aug. 30, 2013 and incorporated herein by reference in its entirety.

### BACKGROUND

1. Technical Field

The present invention relates to encoding/transcoding systems used to process video using High Efficiency Video Coding (HEVC or H-265). More particularly, the present system relates to the use of legacy encoding infrastructures for processing MPEG-4 (also referred to as Advanced Video Coding (AVC) or H-264), MPEG-2 or other type video signals to also enable optimal video quality when encoding in HEVC format.

2. Related Art

State of the art video quality is achieved today by performing complex multi-pass video encoding using the same codec technology for each pass, and incorporating multiple stages in each pass for collecting key video statistics that will be used by the final pass encoder, which in turn applies optimal bit rate allocation on a frame-basis.

While multi-pass encoding achieves optimal video quality, the complexity of performing multiple times the same encoding in real-time is not always possible due to performance limitations of the specific hardware device used for encoding.

Newer video codecs like High Efficiency Video Coding (HEVC) are extremely complex compared to MPEG-4 or MPEG-2. This implies that even though it is feasible to design systems that can handle multipass encoding for MPEG-2 and MPEG-4, designing systems that can perform multi-pass encoding of a newly introduced codec HEVC is a challenge and requires extremely powerful systems that are not currently economically feasible and competitive for all applications.

### SUMMARY

Embodiments of the invention propose to go beyond the conventional multi-pass encoding that is performed today on many real-time video encoders with similar complexity. Instead of trying to achieve multiple times the same encoding for newly introduced video codecs that are often too complex to meet real-time, embodiments of the present invention use a first pass encoder that is less complex, and thus easier to perform in real-time.

As one example, a system of the present invention includes a first pass encoder that is an H-264 encoder followed by a second pass HEVC encoder. The second pass HEVC encoder then performs more complex encoding that is not provided in the H-264 encoder.

Embodiments of the present invention make it possible to perform real-time multi-pass encoding for new and very complex codecs like HEVC by using less complex video codecs, such as an MPEG-2 or an MPEG-4 encoder, along an encoding pipeline. Thus, embodiments of the invention provide a design for a multi-pass encoder that can run real-time under the constraints of a specific appliance, via the use of these heterogeneous video codecs,

Embodiments of the invention allow for a faster development cycle of a multi-pass encoder for a newly introduced codec by reusing the infrastructure and multi-pass design of an established video encoder already dealing with older technology. Heterogeneous multi-pass video encoding can benefit video quality of both the new video codec and the old codec.

Embodiments of the invention do not limit to a less-complex first pass encoding followed by a more-complex second pass encoding. In an alternative embodiment, the less-complex encoding can be performed in the second pass after a more complex first pass. As an example, an MPEG-4 encoder can follow a first pass HEVC encoder.

Another aspect of the present invention considers that in the design for a multi format encoder, it will be expensive to have many multi-pass systems. Accordingly, in one embodiment a cost effective system is provided to have one or multiple common preliminary passes for all output formats, where the last pass will be different and will be based on the desired final output format.

### BRIEF DESCRIPTION OF THE DRAWINGS

Further details of the present invention are explained with the help of the attached drawings in which:

FIG. 1 is a block diagram of components of a multi-pass encoder with heterogeneous codecs; and

FIG. 2 is a diagram showing functions performed by the less complex multi-pass encoder of FIG. 1.

### DETAILED DESCRIPTION

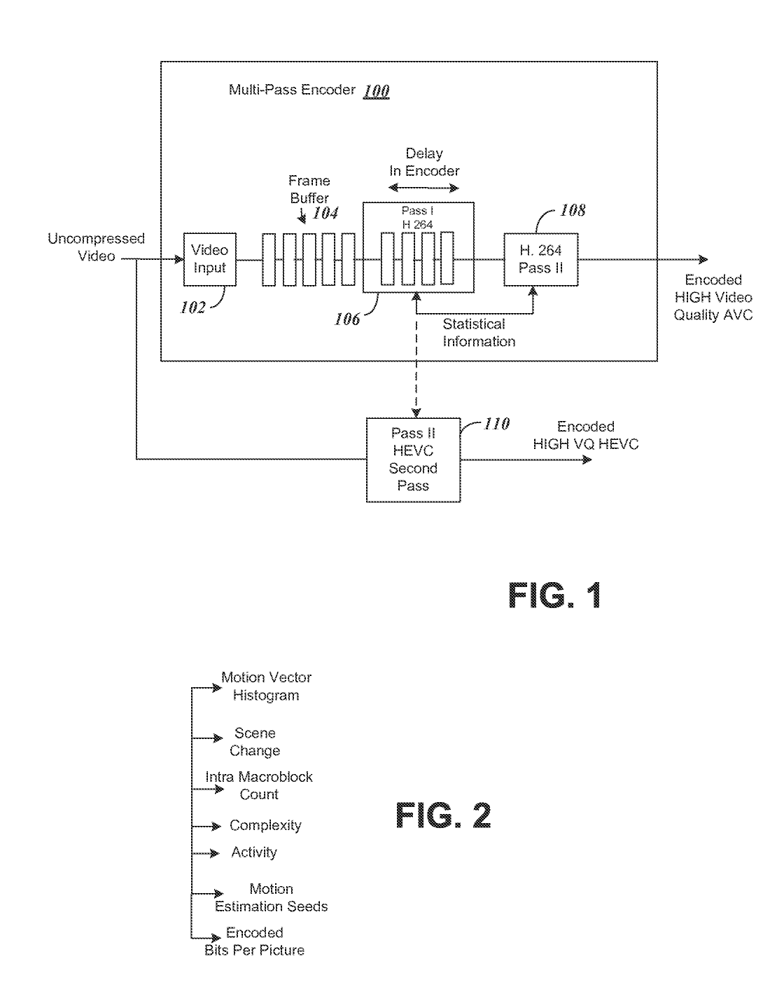

FIG. 1 shows a block diagram of components of a multi-pass encoder with heterogeneous codecs. The system of FIG. 1 illustrates an example embodiment of the present invention with the first pass encoder being an H-264 and a second pass being HEVC. It is understood, however, that the first pass could be an encoder such as the MPEG-2, or an encoder complying with another standard. Further the second pass encoder could comply with another standard other than HEVC. As a further alternative, the first encoder could be more complex than the second encoder.

In FIG. 1, a multi-pass encoder 100 is provided that is a standard H-264 (or MPEG-4) device, along with an HEVC encoder 110. The standard H-264 encoder 100 includes a video input 102 that receives an uncompressed video signal for encoding and provides the video into a frame buffer 104. The output of the frame buffer is provided through a first pass H-264 encoding module 106 that provides a first homogeneous pass that is done again in the H-264 as a second pass in encoding module 108. Statistical information is provided between the pass 1 module 106 to the pass 2 module 108 so that encoding is done more efficiently to provide a compressed High Video Quality Advanced Video Coding (AVC) output signal coded using the H-264 standard.

The pass 1 module 106 includes a multi frame buffer for the H-264 encoding steps. As shown, the statistics generated in the pass 1 module 106 can also be provided as statistical inputs to the HEVC encoder 110, What the HEVC encoder gets is statistics information extracted from the H-264 1^{st} pass, which helps the H-264 second pass, as well as now the HEVC which also constitutes a second pass. The HEVC encoder 110 then can receive the same uncompressed video as the H-264 encoder 100 and use the statistical data from the conventional H-264 encoder 100 to provided improved encoded high video quality HEVC output.

FIG. 2 illustrates the encoding techniques that can be produced from the multi-pass H-264 Encoder 100. Some encoding techniques of the H-264 encoder may not be provided in the HEVC encoder 110, enabling the two pass encoder using H-264 and HEVC processing in the system of FIG. 1 to provide an improved output. The coding techniques illustrated in FIG. 2 included for the H-264 output provide processing for a motion vector histogram, scene change, intra macroblock count, video complexity, video activity, motion estimation seeds and encoded bits per picture. Note that the techniques illustrated in FIG. 2 are not intended to be limiting, and the list can be expanded to include other techniques. The HEVC encoder 110 receives the same uncompressed video as the H-264 system 110 and can make better encoding decisions with statistics provided with information from the coding techniques illustrated in FIG. 2 than a system with the HEVC encoder alone.

The system shown in FIG. 1 uses an older H-264 encoder in combination with the later technology HEVC encoder and allows for a faster development cycle of a multipass encoder for a newly introduced codec by reusing the infrastructure and multipass design of the established H-264 video encoder already dealing with older technology. Heterogeneous multipass video encoding can benefit video quality for new video codecs as well as provide a similar benefit for old codecs.

Embodiments of the invention are not limited to a less-complex first pass encoding followed by a more-complex second pass encoding. In an alternative embodiment to that shown in FIG. 1, the less-complex encoding of the H-264 system can be performed in the second pass after a more complex first HEVC pass.

In a further alternative embodiment a cost effective system can be provided to have a common preliminary pass/passes fir all output formats, where the last pass will be different and will be based on the desired final output format. By having common passes, different multi pass systems can be made less expensive. Such a system can include the components as shown in FIG. 1, with the pass 1 encoder portion 106 used as a common first pass for (1) the H-264 second stage 108 and (2) the HEVC encoder 110, enabling components of the HEVC to be eliminated. Further, although the H-264 second stage is shown, in this system for illustrative purposes this can be eliminated when only the HEVC output is desired. Thus, the initial pass or passes can be common for the H-264 format as well as for the HEVC format.

Although the present invention has been described above with particularity, this was merely to teach one of ordinary skill in the art how to make and use the invention. Ma additional modifications will fall within the scope of the invention as that scope is defined by the following claims.

What is claimed:

1. A system for multipass video coding comprising:
a first pass encoder comprising modules for coding video using an MPEG-4 standard; and
a second pass encoder comprising modules for coding video using an HEVC standard.

2. The system of claim 1, wherein the second pass encoder provides final compression encoding.

3. The system of claim 1, wherein the first pass encoder is designed to provide a first pass to an additional second pass encoder using the MPEG-4 standard.

4. The system of claim 1, wherein the components of the first pass encoder are designed to provide a first pass for an additional second stage for the H-264 standard, and include components common to an encoder for the HEVC standard.

5. The system of claim 1, wherein statistical information is provided from the first pass encoder to the second pass encoder.

6. The system of claim 1, wherein the first pass encoder and the second pass encoder perform encoding in real-time.

7. The system of claim 3, wherein the first pass encoder stages extract key video statistics different than statistics extracted in the second pass encoder.

8. The system of claim 4, wherein the statistical information includes at least one of:
motion vector histogram information, scene change information, an intra macroblock count, video complexity, video activity, motion estimation seeds, and encoded bits per picture.

9. A system for multipass video coding comprising:
a first pass encoder comprising modules for coding video using a first standard; and
a second pass encoder comprising modules for coding video using a second standard more complex than the first standard.

10. The system of claim 9, wherein the second pass encoder is a more recently developed system while the first pass encoder is an established system used in the industry for a longer period of time.

11. The system of claim 9, wherein the second pass encoder comprises an HEVC device, while the first encoder comprises one of: an MPEG-2 encoder and an MPEG-4 encoder.

12. The system of claim 9, wherein the components of the first pass encoder are designed to provide a common preliminary pass information to additional final passes for each final pass in a multi format encoder.

13. The system of claim 9, wherein the first pass encoder is designed to provide a first pass to an additional second. pass encoder.

14. The system of claim 13, further comprising additional pass encoders provided prior to the second pass encoder.

15. A system for multipass video coding comprising:
a first pass encoder comprising modules for coding video using a first standard; and
a second pass encoder comprising modules for coding video using a second standard less complex than the first standard.
